(19) United States
(12) Patent Application Publication
(10) Pub. No.: US 2006/0224679 A1
(43) Pub. Date: Oct. 5, 2006

(54) Mail server, mail receiving apparatus, mail server program storage medium, and mail receiving program storage medium

(75) Inventors: Yoshimitsu Kikuchi, Sapporo (JP); Kiyotaka Sawae, Sapporo (JP); Shinichi Matsuya, Sapporo (JP); Hiroshi Watanabe, Sapporo (JP); Tadato Tomikawa, Sapporo (JP); Yoshikatsu Kimura, Sapporo (JP); Wataru Miyauchi, Sapporo (JP); Atsushi Shibayama, Sapporo (JP); Takahisa Ishikawa, Sapporo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/188,885

(22) Filed: Jul. 26, 2005

(30) Foreign Application Priority Data
Mar. 30, 2005 (JP) 2005-098273

(51) Int. Cl. G06F 15/16

(52) U.S. Cl. 709/206

(57) ABSTRACT

There are provided a mail server, a mail receiving apparatus, a mail server program storage medium, and a mail receiving program storage medium, the mail server which relays transmission and reception of electronic mail including a mail receiving section which receives electronic mail to which an attachment file is attached and which is accompanied by accompanying information which describes modes of treating the attachment file in association with plural recipient types into which recipients are categorized, an attachment file processing section which processes the attachment file of the electronic mail received at the mail receiving section in accordance with the type of recipients on the basis of the accompanying information which accompanies the electronic mail, and a mail sending section which sends the electronic mail the attachment file of which has been processed by the attachment file processing section to recipients of the electronic mail.

### BACKGROUND OF THE INVENTION

1. Field of the Invention

The present invention relates to a mail server which relays transmission and reception of electronic mail, a mail receiving apparatus which receives electronic mail, a mail server program storage medium having stored thereon a mail server program causing a computer to function as a mail server, and mail receiving program storage medium having stored thereon a mail receiving program causing a computer to function as a mail receiving apparatus.

2. Description of the Related Art

With the proliferation of personal computers and remarkable improvements in communication technology, electronic mail has become popular and has been used as common information communicating means. General-purpose electronic mailing software is typically installed in personal computers and cellular phones including mail facilities. Electronic mail can be sent by using an edit screen provided by the electronic mailing software to specify a mail address in a recipient address field, specifying an attachment file, editing a mail message, and then selecting a send button. Further, electronic mail can be sent to multiple mail addresses by specifying the mail addresses in the recipient address field without the need for creating multiple copies of the same electronic mail.

When electronic mail is used within a company, copies of the same electronic mail are often sent to multiple recipients. The multiple recipients may include important recipients to which an attachment file must be sent with the mail message, secondary recipients to which only the mail message needs to be sent for information purpose, and cellular phones that can receive only electronic mail of small data size at a time. If electronic mail with an attachment file is created and multiple addresses are specified in its recipient field in conventional mailing software, the electronic mail with the attachment file is sent to all mail addresses specified. However, some of the recipients may not be able to receive attachment files of large data size, or do not need the attachment file, which may consume extra time and communication charge or storage at the recipients. To solve such a problem, two pieces of electronic mail having the same message with and without the attachment file may be created and one of the two pieces of electronic mail may be sent selectively depending on recipients. However, this method has the drawback of requiring the labor of creating the two pieces of electronic mail with the same message.

With regard to the problem, Japanese Patent Laid-Open No. 11-212884 describes a method in which an attachment file is selectively assigned to each of multiple types of recipient addresses (To; Cc, carbon copy; and Bcc, blind carbon copy) which are provided in typical electronic mailing software and recipient mail addresses are categorized into the multiple types, thereby sending electronic mail with the attachment file and electronic mail without the attachment file. According to that method, a user can specify whether to attach an attachment file by specifying a mail address as one of the address types, without having to creating two pieces of electronic mail having the same message.

However, the approach described in Japanese Patent Laid-Open No. 11-212884 has the problem that two copies of electronic mail, one with an attachment file and the other without the attachment file, are sent from the client device generating the electronic mail to the mail server which relays transmission of electronic mail, which increases communication traffic between the mail client and the mail server.

### SUMMARY OF THE INVENTION

The present invention has been made in view of the above circumstances and provides a mail server, a mail receiving apparatus, a mail server program, and a mail receiving program that enable pieces of electronic mail to which an attachment file is attached or not attached depending on recipients to be sent without increasing communication traffic between a mail client device and a mail server.

The present invention provides a mail server which relays transmission and reception of electronic mail, including: a mail receiving section which receives electronic mail to which an attachment file is attached and which is accompanied by accompanying information which describes modes of treating the attachment file in association with plural recipient types into which recipients are categorized; an attachment file processing section which processes the attachment file of the electronic mail received at the mail receiving section in accordance with the type of recipients on the basis of the accompanying information which accompanies the electronic mail; and a mail sending section which sends the electronic mail the attachment file of which has been processed by the attachment file processing section to recipients of the electronic mail.

According to the mail server of the present invention, the attachment file attached to the electronic mail is processed in accordance with the types of the recipients on the basis of the accompanying information which accompanies the electronic mail and the electronic mail of which the attachment file has been processed is sent to the recipients. For example, if electronic mail is received in which information indicating whether an attachment file is to be attached or not is associated with the three recipient types, To (a primary recipient), Cc (a secondary recipient), and Bcc (a recipient to which mail addresses are not disclosed), which have been widely used and multiple recipients are categorized into the three recipient types, the electronic mail to which the attachment file is attached or the electronic mail from which the attachment file is excluded is sent according to the types of the recipients. Because electronic mail in which multiple recipient addresses are specified is sent from a mail client, the sender of the electronic mail, only once, the electronic file with and without the attachment file depending on the recipients can be sent without increasing communication traffic between the mail client device and the mail server.

Preferably, in the mail server of the present invention, the accompanying information which accompanies the electronic mail received at the mail receiving section is attachment permission/prohibition information instructing whether the attachment file is to be kept attached to the electronic mail or excluded from the electronic mail in accordance with the type of recipients, and the attachment file processing section keeps the attachment file attached to the electronic mail or excludes the attachment file from the electronic mail according to the type of recipients on the basis of the attachment permission/prohibition information.

Because the attachment file is attached to or excluded from the electronic mail in accordance with type of the recipients, the attachment file can be sent only to the recipient that requires the attachment file.

In the mail server of the present invention, preferably the mail server according to the present invention, wherein the accompanying information which accompanies the electronic mail received at the mail receiving section is storage instructing information which instructs to exclude the attachment file from the electronic mail and to store the attachment file separately from the electronic mail, and the attachment file processing section stores the attachment file of the electronic mail and excludes the attachment file from the electronic mail to be sent to a recipient of the type associated with the storage instructing information and generates a piece of electronic mail to which the address at which the attachment file is stored is added.

The mail server according to this preferable embodiment allows a recipient for whom an attachment file is excluded from electronic mail to see the attachment file by referring to its storage address attached to the electronic mail.

The present invention also provides a mail receiving apparatus which receives electronic mail sent from a mail server which relays transmission and reception of electronic mail, including; a mail receiving section which receives electronic mail with information indicating whether or not an attachment file is excluded from the electronic mail; a display which displays the electronic mail received at the mail receiving section; and a display control section which, if an attachment file is excluded from the electronic file received at the mail receiving section, causes information indicating that an attachment file is excluded from the electronic mail to be displayed on the display along with the electronic mail.

The mail receiving apparatus of the present invention allows a user to readily know that an attachment file is excluded from electronic mail sent from the mail server.

The present invention also provides a mail server program storage medium having stored thereon a mail server program to be executed in a computer system to cause the computer system to relay transmission and reception of electronic mail, the mail server program configuring on the computer system having: a mail receiving section which receives electronic mail to which an attachment file is attached and which is accompanied by accompanying information which describes modes of treating the attachment file in association with plural recipient types into which recipients are categorized; an attachment file processing section which processes the attachment file of the electronic mail received at the mail receiving section in accordance with the type of recipients on the basis of the accompanying information which accompanies the electronic mail; and a mail sending section which sends the electronic mail the attachment file of which has been processed by the attachment file processing section to recipients of the electronic mail.

The mail server program of the present invention can cause a computer to function as a mail server that can send electronic mail with or without an attachment file depending on the recipients.

Any of the components such as the mail receiving section that are configured by the mail server program according to the present invention may be a single component configured by a single program component, may be a single component configured by multiple program components, or may be multiple components configured by a single program component. Also, the program itself may implement these components or may instruct another program or components thereof to implement these components.

While only basic implementations of the mail server program of the present invention are described herein only to avoid overlapping, the mail server program according to the present invention is not limited to the basic implementations. Instead, various implementations that correspond to the implementations of the mail server described above are also included in the mail server program.

The present invention also provides a mail receiving program storage medium having stored thereon a mail receiving program to be executed in a computer system to cause the computer system to receive electronic mail sent from a mail server which relays transmission and reception of electronic mail, the mail receiving program configuring on the computer system having: a mail receiving section which receives electronic mail with information indicating whether or not an attachment file is excluded from the electronic mail; a display which displays the electronic mail received at the mail receiving section; and a display control section which, if an attachment file is excluded from the electronic file received at the mail receiving section, causes information indicating that an attachment file is excluded from the electronic mail to be displayed on the display along with the electronic mail.

The mail receiving program of the present invention can cause a computer to function as a mail receiving apparatus which allows a user to readily know that an attachment file is excluded from electronic mail sent from the mail server.

Any of the components such as the mail receiving section that are configured by the mail server program according to the present invention may be a single component configured by a single program component, may be a single component configured by multiple program components, or may be multiple components configured by a single program component. Also, the program itself may implement these components or may instruct another program or components thereof to implement these components.

As has been described above, the present invention can provide a mail server, a mail receiving apparatus, a mail server program storage medium, and a mail receiving program storage medium that enable pieces of electronic mail to which an attachment file is attached or not attached depending on recipients to be sent without increasing communication traffic between a mail client device and a mail server.

### BRIEF DESCRIPTION OF THE DRAWINGS

FIG. 1 schematically shows an exemplary communication system to which one embodiment of the present invention is applied;

FIG. 2 is a hardware configuration of a personal computer 10;

FIG. 3 shows functional blocks required for implementing functions unique to the embodiment on the personal computer 10;

FIG. 4 shows an exemplary mail editing screen;

FIG. 5 shows an example of edited electronic mail;

FIG. 6 shows functional blocks required for implementing functions unique to the embodiment on a mal server 20;

FIG. 7 is a flowchart of a process flow performed on the mail server 20;

FIG. 8 shows an image of electronic mail created in an attachment file processing section 320;

FIG. 9 is a flowchart of process flow performed on personal computers 10A, 10B, and 10C; and

FIG. 10 shows an exemplary electronic mail display screen.

### DETAILED DESCRIPTION OF THE INVENTION

Embodiments of the present invention will be described with reference to the accompanying drawings.

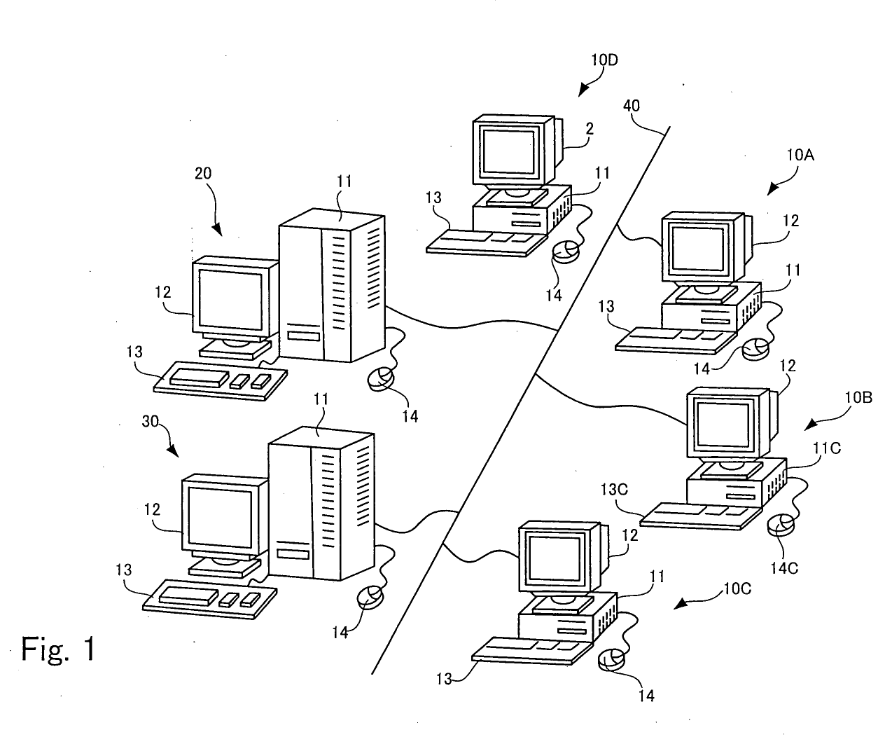

FIG. 1 schematically shows an example of a communication system to which one embodiment of the present invention is applied.

Shown in FIG. 1 are four personal computers 10A, 10B, 10C, and 10D (hereinafter collectively referred to as PC 10) having an electronic mailing facility, a mail server 20 which relays electronic mail sent to the PC 10, a Web server 30 on which various files are stored, and a communication network 40 which interconnects the PC 10, the mail serve 20, and the Web serve 30. While many PC and other devices are connected to the communication network 40 in practice, only the components required for describing the present invention are shown in FIG. 1 for simplicity.

In the present embodiment, electronic mail destined to the PC 10 is received and stored at the mail server 20. When a request for receiving the mail is sent from the PC 10 to the mail server 20, the electronic mail received and stored on the mail server 20 is sent to the PC 10 and received by the PC 10.

In the present embodiment, the mail server 20 and the Web server 30 are workstations or a large-scale computer having a larger capacity of the memory and higher throughput of the CPU than the PC 10; however, their appearances and hardware configurations are similar to those of the PC 10. In the following description, like components of the PC 10, the mail server 20, and the Web server 30 are labeled with like reference numerals and a configuration of the PC 10 will be described as a typical example.

The PC 10, as viewed from outside, includes a system unit 11, a display 12 on which images are displayed in response to instructions from the system unit 11, a keyboard 13 which inputs various types of information into the system unit 11 in response to key operations, and a mouse 14 for specifying a particular position on the display 12 to input an instruction corresponding to an icon, for example, displayed in that position.

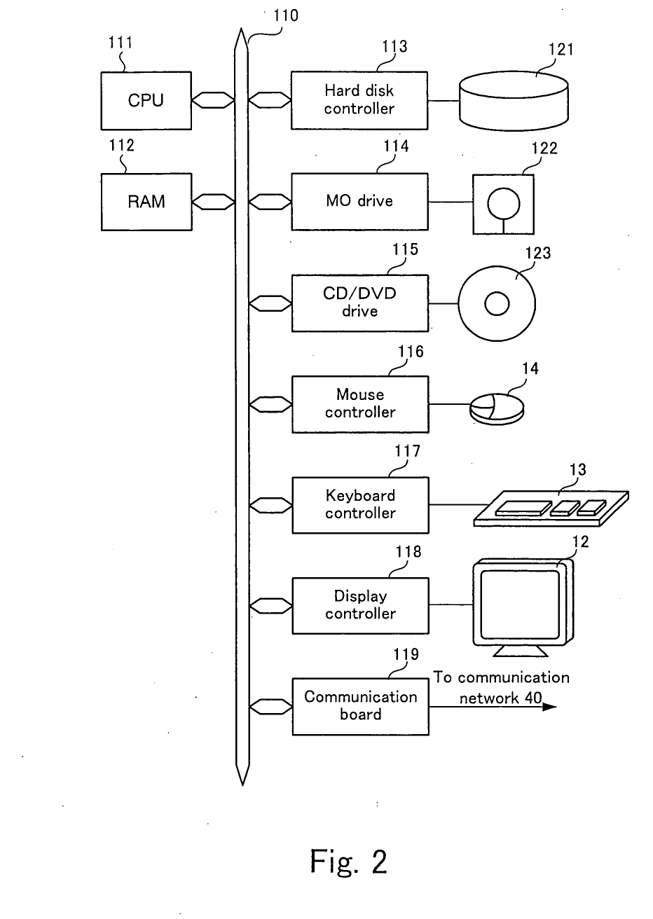

FIG. 2 shows a hardware configuration of the PC 10.

As shown in FIG. 2, contained in the system unit 11 are a CPU 111 which executes programs, a RAM 112 into which a program stored in a hard disk unit 121 is read and loaded for execution by the CPU 111, the hard disk unit 121 in which programs and data are stored, a hard disk controller 113 which controls access to the hard disk unit 121, an MO drive 114 which accesses an MO 122 loaded therein, a CD/DVD drive 115 which accesses a CD-ROM 123 or a DVD, a display controller 118, a keyboard controller 117, and a mouse controller 116 which control the display 12, keyboard 13, and mouse 14 shown in FIG. 1, respectively, and a communication board 119 which sends and receives a data to and from the mail server 20 and the Web server 30 shown in FIG. 1. These components are interconnected through a bus 110.

The mail server 20 and the Web server 30 have basically the same configuration as that of the PC 10 described above.

Described below are functions of a data receiving apparatus of the present invention in the PC 10 according to one embodiment and functions of the mail server of the present invention in the mail server 20 according to one embodiment.

Functions performed on the PC 10 will be described first.

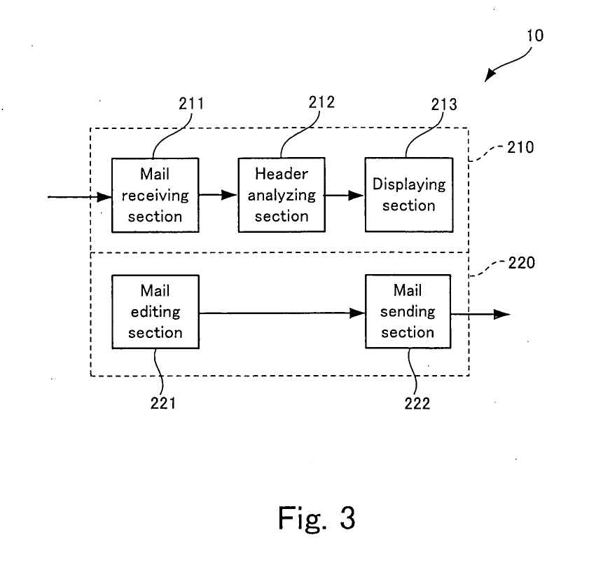

FIG. 3 shows functional blocks required for implementing functions unique to the present embodiment, which are formed by a combination of the hardware of the PC 10 shown in FIG. 1 and a program executed on the CPU 111 of the PC 10.

The PC 10 has a sending function of editing and sending electronic mail and a receiving function of receiving electronic mail and displaying it on the display 12. Shown in FIG. 3 are a receiving section 210 including a mail receiving section 211, a header analyzing section 212, and a displaying section 213 and a sending unit 220 including a mail editing section 221 and a mail sending section 222.

A mail edit screen for a user to edit electronic mail is originally provided in the PC 10.

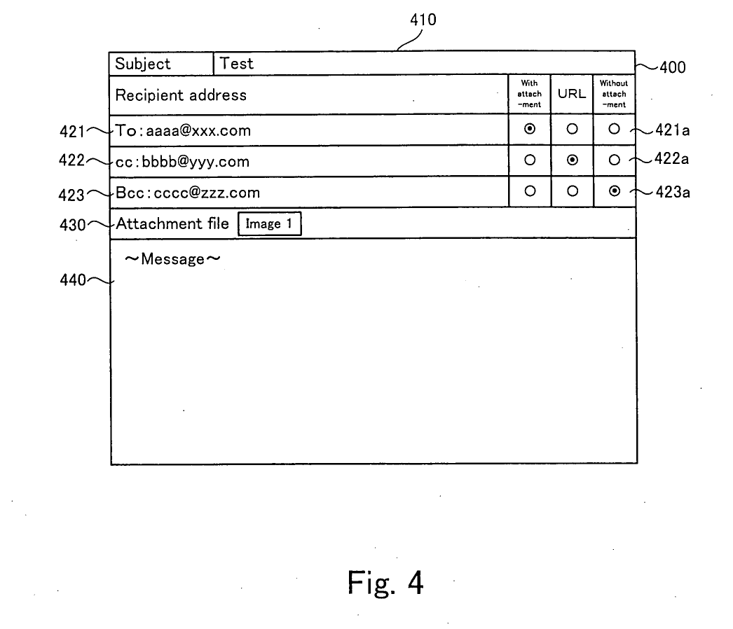

FIG. 4 shows an example of the mail edit screen.

In the PC 10, electronic-mail recipient addresses can be specified as one of three types: a TO type which represents a main recipient, a CC type which represents a secondary recipient, and a BCC type in which the address of the recipient is not notified to the TO and CC-type recipients. Provided on the mail edit screen 400 are a subject edit field 410 in which the subject of electronic mail is edited, a TO specifying field 421 in which a TO-type address is specified, a CC specifying field 422 in which a CC-type address is specified, a BCC specifying field 423 in which a BCC-type address is specified, an attachment file specifying field 430 in which an attachment file is specified, a message edit field 440 in which a mail message is edited, and attachment buttons 421a, 422a, and 423a for specifying one of three attachment modes (mode 1: the attachment file is attached, mode 2: the address on the Web server 30 (see FIG. 1) at which the attachment file is stored is attached, and mode 3: neither the attachment file nor the storage address is attached) which indicate whether or not an attachment file should be sent to the recipients categorized as each of the address types.

The keyboard 13 and the mouse 14 shown in FIG. 1 act as the mail edit section 221 shown in FIG. 3 for editing electronic mail according to information inputted by a user using the mail edit screen 400.

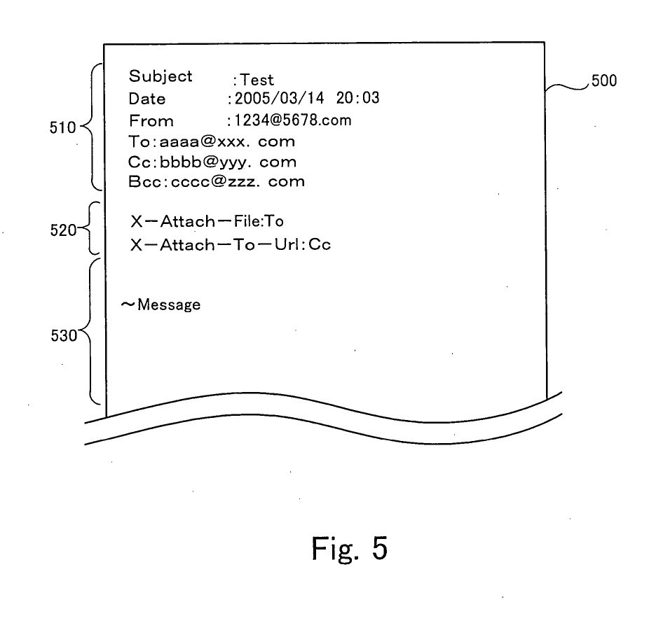

FIG. 5 shows an example of edited electronic mail.

An electronic mail 500 includes a primary header 510 which is edited according to information specified in the subject edit field 410, the attachment file specifying field 430, the TO specifying field 421, the CC specifying field 422, and the BCC specifying field 423, and the mail address of the PC 10; an extension header 520 which is edited according to information specified with the attachment buttons 421a, 422a, and 423a; a mail message 530 which is edited according to edits made in the message edit field 440; and an attachment file (not shown). The extension header 520 represents an example of accompanying information as used in the present invention.

Electronic mail edited in the mail editing section 221 shown in FIG. 3 is provided to the mail sending section 222.

The mail sending section 222 sends the electronic mail edited in the mail edit section 221 to the mail server 20 through the communication board 119 shown in FIG. 2.

The mail receiving section 211 receives electronic mail sent from the mail server 20. The electronic mail received is provided to the header analyzing section 212. The mail receiving section 211 represents an example of the mail receiving section in the mail receiving apparatus of the present invention.

The header analyzing section 212 analyzes on the basis of the primary header 510 and the extension header 520 shown in FIG. 5 whether or not a piece of electronic mail received at the mail receiving section 211 is one from which an attachment file is excluded. The method for analyzing this will be described in detail later. If an attachment file is excluded from the electronic mail, the header analyzing section 212 causes the displaying section 213 to display notification that an attachment file is excluded. The header analyzing section 212 represents the display control section of the mail receiving apparatus of the present invention.

The display 12 and the display controller 117 shown in FIG. 2 act as the displaying section 213, which displays electronic mail received at the mail receiving section 211. The displaying section 213 also displays notification that an attachment file is excluded, along with the electronic mail, if a direction to display such notification is provided from the header analyzing section 212. The displaying section 213 represents an example of the display of the mail receiving apparatus of the present invention.

Functions performed on the mail server 20 will be described below.

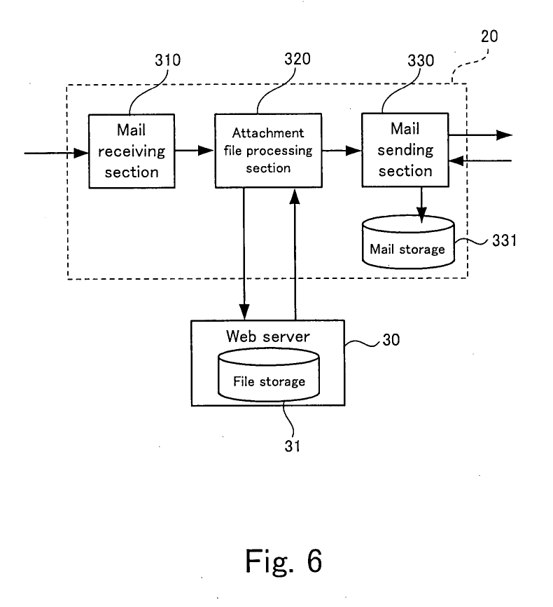

FIG. 6 shows functional blocks required for implementing functions unique to the present embodiment, which are formed by the hardware of the mail server 20 shown in FIG. 1 and a program executed on the CPU 111 of the mail sever 20.

Shown in FIG. 6 are a mail receiving section 310, an attachment file processing section 320, a mail sending section 330, and a mail storage 331. The Web server 30 shown in FIG. 1 is also shown in FIG. 6.

The mail receiving section 310 receives electronic mail destined to the PC 10 shown in FIG. 3. The electronic mail received is provided to the attachment file processing section 320. The electronic mail receiving section 310 represents one example of the mail receiving section of the mail server of the present invention.

The attachment file processing section 320 obtains, from the primary header 510 and extension header 520 in electronic mail (see FIG. 5) an attachment mode (mode 1: an attachment file is attached, mode 2: an attachment file is not attached but the address on the Web server 30 at which the attachment file is stored is attached, and mode 3: neither of the attachment file and the address is attached) for each of the TO, CC, and BCC address types, and generates a piece of electronic mail according to each attachment mode. That is, the attachment file processing section 320 generates a piece of electronic mail to which an attachment file is attached for addresses of attachment mode 1; stores the attachment file in the file storage 31 on the Web server 30, obtains the URL at which the attachment file is stored, and generates a piece of electronic mail to which the URL of the storage location is added to the mail message for addresses of attachment mode 2; and generates a piece of electronic mail excluding the attachment file for addresses of attachment mode 3. The pieces of electronic mail generated are provided to the mail sending section 330. The attachment file processing section 320 represents an example of the attachment file generating section of the mail server of the present invention.

The mail sending section 330 temporarily stores electronic mail provided from the attachment file processing section 320 in the mail storage 331. The hard disk unit 121 (see FIG. 2) of the mail server,20 acts as the mail storage 331. When receiving a request for receiving mail from a device, such as a PC 10, to which electronic mail is destined, the mail sending section 330 sends the electronic mail stored in the mail storage 331 to the PC 10. The mail sending section 330 represents an example of the mail sending section of the mail server of the present invention.

The PC 10 and the mail server 20 basically have the functions as described above.

Processes performed on a PC 10 and the mail server 20 will be detailed below with respect to an electronic mail sending and receiving procedure in the communication system shown in FIG. 1.

The assumption in the following description is that PC 10D shown in FIG. 1 sends electronic mail to each of the remaining PCs 10A, 10B, and 10C as follows: it sends an electronic mail with an attachment file to PC 10A (attachment mode 1), the piece of electronic mail without the attachment file but with the URL of the location on the Web server 30 at which the attachment file is stored to PC 10B (attachment mode 2), and the piece of electronic mail without the attachment file and the storage URL to the PC 10C (attachment mode 3).

On PC 10D to which the electronic mail is destined, a user specifies the mail address of the PC 10A in the TO specifying field 421 as shown in FIG. 4, selects the “With attachment” attachment button 421a for the field, specifies the mail address of PC 10B in the CC specifying field 422, selects the “URL” attachment button-422a for the field, specifies the mail address of PC 10C in the BCC specifying field 423, and selects the “Without attachment” button 423a for the field. As a result, the mail editing section 221 (see FIG. 3) of PC 10D edits electronic mail 500 by writing the mail address of PC 10A as a TO-type recipient address in the primary header 510 and the mail address of PC 10B as a CC-type recipient address, and the mail address of PC 10C as a BCC-type recipient address, and describing that the attachment file is to be added to the mail to the TO-type recipient and the URL of the storage location of the attachment file is to be added to the mail to the CC-type recipient (neither the attachment file nor its storage URL is added to the mail to the BCC-type recipient). The electronic mail 500 is sent from the mail sending section 222 of PC 10D to the mail server 20.

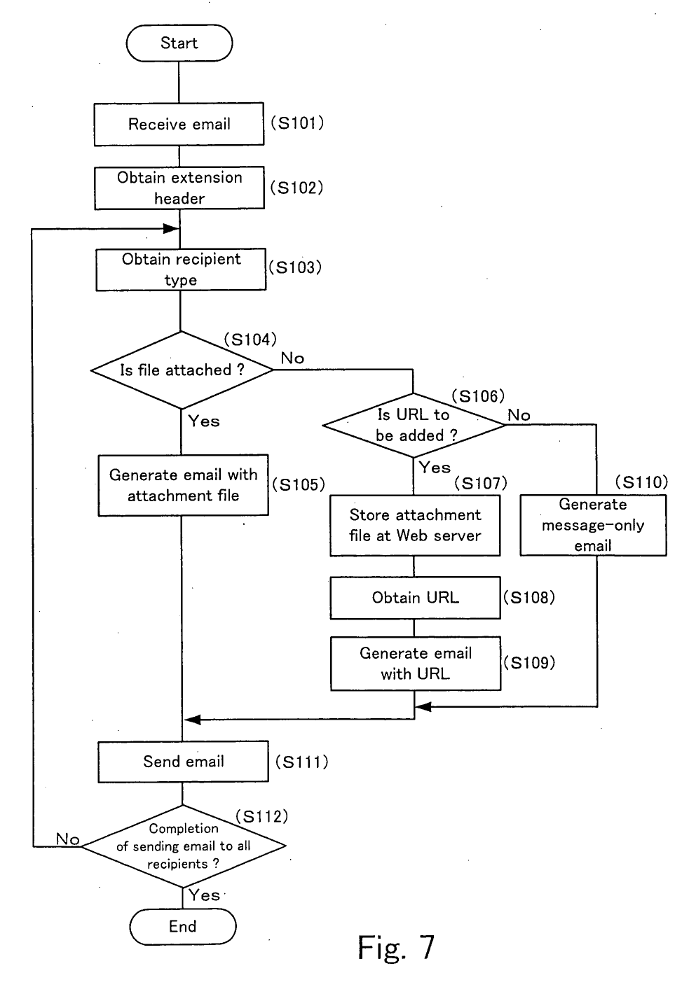

FIG. 7 is a flowchart of a process flow performed on the mail server 20.

The electronic mail 500 sent from PC 10D is received at the email receiving section 310 shown in FIG. 6 (step S101 in FIG. 7). The electronic mail 500 received is provided to the attachment file processing section 320.

The attachment file processing section 320 obtains the extension header 520 of the electronic mail 500 (step S102 in FIG. 7). It recognizes that the attachment file is to be added to the mail to the TO-type address and the URL of the storage location of the attachment file is to be added to the mail to the CC-type recipient (neither the attachment file nor its storage URL is added to the mail to the BCC-type recipient).

Then, the types of the addresses written in the primary header 510 of the electronic mail 500 are sequentially obtained (step S103 in FIG. 7). The TO-type address is obtained first in this example.

Because attachment mode 1 in which an attachment file is added is selected for the TO type (step S104 in FIG. 7: Yes), the attachment file processing section 320 generates a piece of electronic mail according to the primary header 510, extension header 520, mail message 530, and attachment file of the electronic mail 500 (step S105 in FIG. 7).

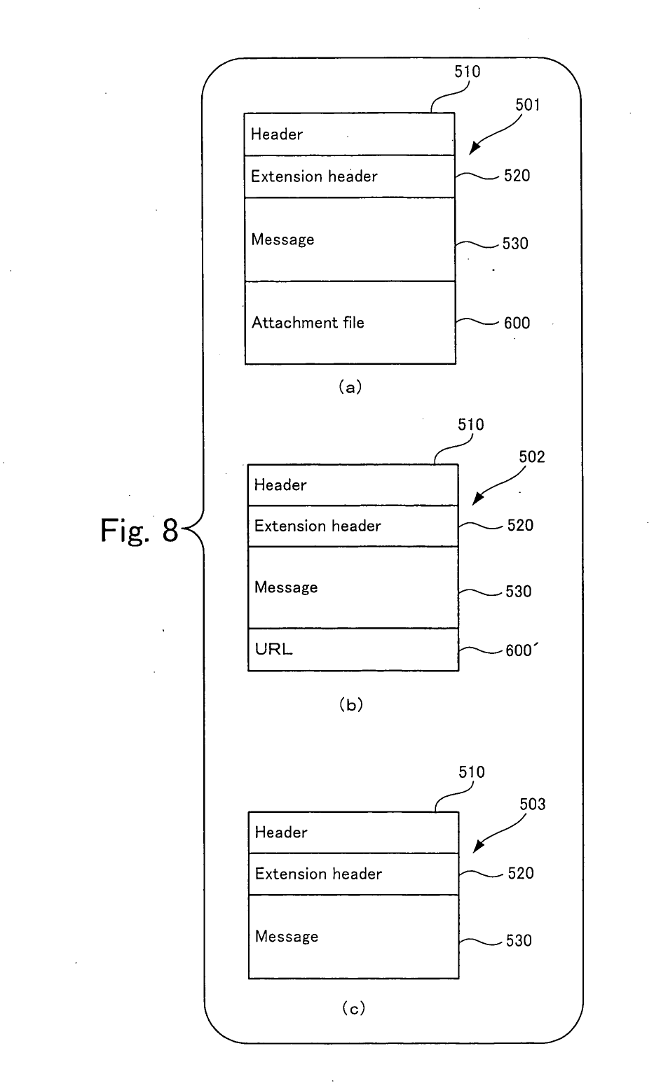

FIG. 8 shows an image of electronic mail generated by the attachment file processing section 320.

For the address type in attachment mode 1, a piece of electronic mail 501 consisting of the primary header 510, the extension header 520, the mail message 530, and the attachment file 600 is generated as shown in Part (a) of FIG. 8. The piece of electronic mail 501 generated is provided to the electronic mail sending section 330 shown in FIG. 6 and is temporarily stored in the mail storage 331. When a mail send request is sent from PC 10A, which is the TO-type recipient, the mail sending section 330 sends the piece of electronic mail 501 stored in the mail storage 331 to the PC 10A (step S111 in FIG. 7).

Then, the CC-type recipient address is obtained at step S103 in FIG. 7.

Because mode 2 is set for the CC-type recipient, in which the attachment file is not to be added (step S104 in FIG. 7: No) but the URL of the storage location of the attachment file is to be added (step S106 in FIG. 7: Yes), the attachment file processing section 320 in FIG. 6 sends the attachment file to the Web server 30 (step S107 in FIG. 7). At the Web server 30, the attachment file sent is stored in the file storage 31 and the storage location URL is sent to the attachment file processing section 320 (step S108 in FIG. 7). The attachment file processing section 320 adds the storage URL obtained to the mail message 530 of the electronic mail 500 shown in FIG. 5 (step S109 in FIG. 7).

For the attachment mode 2 recipient, a piece of electronic mail 502 is generated in which the primary header 510, the extension header, and the mail message 530 are written and the URL 600′, of the storage location of the attachment file is written as shown in Part (b) of FIG. 8. The piece of electronic mail 502 is also provided to the mail sending section 330 and, when a mail-send request is sent from PC 10B, which is the recipient of the CC-type mail, it is sent to PC 10B (step 111 in FIG. 7).

Finally, the BCC-type recipient address is obtained at step S103 in FIG. 7.

Because attachment mode 3 is set for the BCC-type recipient in which neither the attachment file nor the storage URL is added (steps S104 and S106 in FIG. 7: No), the attachment file processing section 320 shown in FIG. 6 generates a piece of electronic mail excluding the attachment file (step S110 in FIG. 7).

For the recipient type for which mode 3 is set, a piece of electronic mail 503 is generated in which only the primary header 510, the extension header 520, and the mail message 530 are contained as shown in Part (c) of FIG. 8. The piece of electronic mail 503 is also provided to the mail sending section 330 and, when a mail-send request is sent from PC 10C, which is the recipient of the BCC-type mail, it is sent to PC 10C (step S111 in FIG. 7).

The following process is performed at the mail server 20.

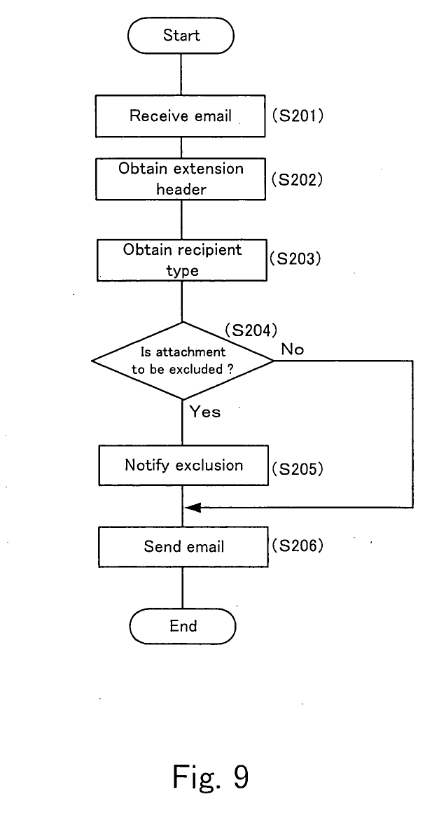

FIG. 9 is a flowchart of a process flow performed on PCs 10A, 10B, and 10C.

To receive electronic mail at any of PCs 10A, 10B, and 10C, its mail receiving section 211 shown in FIG. 3 sends a receive request to the mail server 20 and the mail sending section 330 sends a piece of electronic mail 501, 502, and 503 destined to the PC10A, 10B, 10C. The piece of electronic mail sent is received at the mail receiving section 211 shown in FIG. 3 (step S201 in FIG. 9) and provided to the header analyzing section 212.

The header analyzing section 212 obtains the extension header 520 of the electronic mail and the recipient type of the PC which is written in the primary header 510 (steps 202 and 203 in FIG. 9).

In this example, the header analyzing section 212 obtains the extension header 520 indicating that the attachment is to be attached to the mail to the TO-type recipient and its storage URL is to be added to the mail to the CC-type recipient (neither the attachment file nor the storage URL is to be added to the mail to the BCC-type). For example, at PC 10A, the TO type is obtained as its recipient type and accordingly it is determined that an attachment file is attached to the piece of electronic mail 501 (see Part (a) of FIG. 8) sent to PC 10A (step S204 in FIG. 9: No). Consequently, only the piece of electronic mail 501 is displayed on the displaying section 213 of PC 10A (step S206 in FIG. 9).

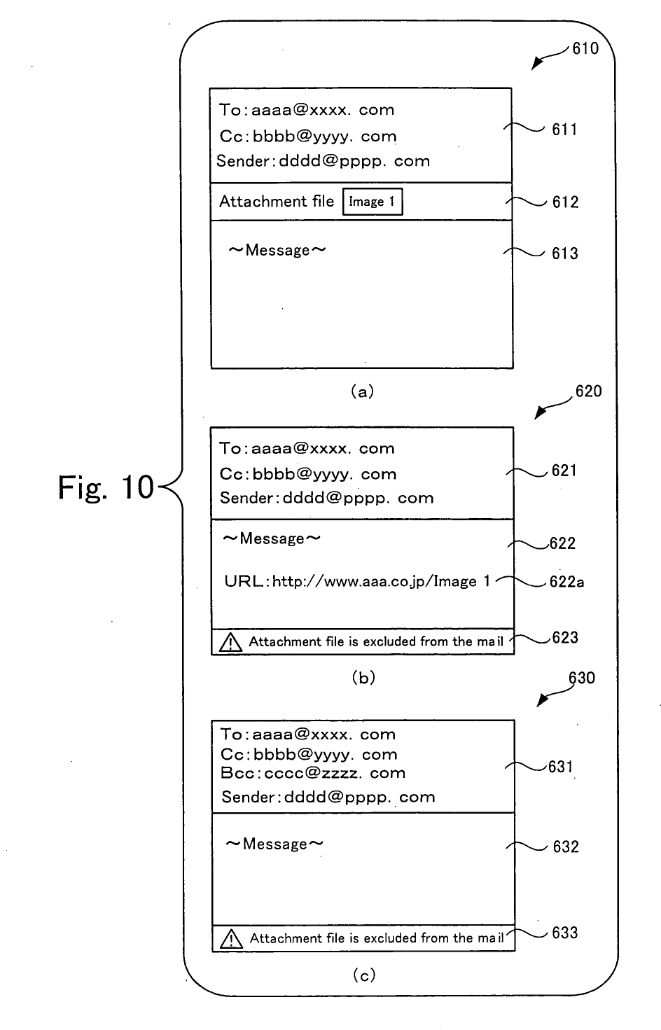

FIG. 10 shows an exemplary electronic mail display screen.

As shown in Part (a) of FIG. 10, a mail screen 610 including a header 611 based on the primary header 510 of the electronic mail 501, and an attachment file name 612 based on the attachment file 600, and a message 613 based on the message 530 are displayed on PC 10A.

On PC 10B, it is determined that an attachment file is excluded from the electronic mail 502 sent to PC 10B because the CC type is obtained as its recipient type (step S204 in FIG. 9: Yes). The header analyzing section 212 provides an instruction to the displaying section 213 to display notification that an attachment file is excluded.

The displaying section 213 of PC 10B displays a mail screen 620 including a header 621 based on the primary header 510 of the electronic mail 502, a send-to URL 622a based on the send-to URL 600′, a message 622 based on the message 530, and the notification 623 that an attachment file is excluded as shown in Part (b) of FIG. 10. A user of PC 10B can see the attachment file by specifying the send-to URL 622a with a mouse 14B or the like.

On PC 10C, The BCC-type is obtained as its recipient type and accordingly it is determined that an attachment file is excluded from the electronic mail 503 (step S204 in FIG. 9: Yes).

The displaying section 213 of the PC 10C, a screen 630 including a header 631 based on the primary header 510 of the electronic mail 503, a message 632 based on the message 530, and a notification 633 that an attachment file is excluded, as shown in Part (c) of FIG. 10. A user of PC 10C can know from the attachment file exclusion notification 633 that a file attached to the electronic mail 503 is excluded.

As has been described, the present embodiment reduces communication traffic between a mail client device (PC 10D) that sends electronic mail and the mail server 20, and allows electronic mail to be sent with or without an attachment file depending on recipients.

While the mail server in the example described above temporarily stores electronic mail destined to PCs at the mail server sent to the PCs in response to a receive request from the PCs, the mail server of the present invention may send electronic mail to another mail server without storing it.

While the mail server in the example described above relays electronic mail destined to PCs, the mail server of the present invention may relay electronic mail destined to cellular phones.

While an example has been described in which electronic mail to which an extension header that associates the types of recipients with modes of treating an attachment file is received at the mail server, the association between the types of recipients and modes of treating an attachment file may be pre-established between a mail client device and the mail server and the mail server of the present invention may receive electronic mail to which only the primary header is attached. In that case, the recipient type itself written in the primary header represents accompanying information as used in the present invention.

What is claimed is:

1. A mail server which relays transmission and reception of electronic mail, comprising:
a mail receiving section which receives electronic mail to which an attachment file is attached and which is accompanied by accompanying information which describes modes of treating the attachment file in association with a plurality of recipient types into which recipients are categorized;
an attachment file processing section which processes the attachment file of the electronic mail received at the mail receiving section in accordance with the type of recipients on the basis of the accompanying information which accompanies the electronic mail; and
a mail sending section which sends the electronic mail the attachment file of which has been processed by the attachment file processing section to recipients of the electronic mail.

2. The mail server according to claim 1, wherein the accompanying information which accompanies the electronic mail received at the mail receiving section is attachment permission/prohibition information instructing whether the attachment file is to be kept attached to the electronic mail or excluded from the electronic mail in accordance with the type of recipients, and the attachment file processing section keeps the attachment file attached to the electronic mail or excludes the attachment file from the electronic mail according to the type of recipients on the basis of the attachment permission/prohibition information.

3. The mail server according to claim 1, wherein the accompanying information which accompanies the electronic mail received at the mail receiving section is storage instructing information which instructs to exclude the attachment file from the electronic mail and to store the attachment file separately from the electronic mail, and the attachment file processing section stores the attachment file of the electronic mail and excludes the attachment file from the electronic mail to be sent to a recipient of the type associated with the storage instructing information and generates a piece of electronic mail to which the address at which the attachment file is stored is added.

4. A mail receiving apparatus which receives electronic mail sent from a mail server which relays transmission and reception of electronic mail, comprising;
a mail receiving section which receives electronic mail with information indicating whether or not an attachment file is excluded from the electronic mail;
a display which displays the electronic mail received at the mail receiving section; and
a display control section which, if an attachment file is excluded from the electronic mail received at the mail receiving section, causes information indicating that an attachment file is excluded from the electronic mail to be displayed on the display along with the electronic mail.

5. A mail server program storage medium having stored thereon a mail server program to be executed in a computer system to cause the computer system to relay transmission and reception of electronic mail, the mail server program configuring on the computer system comprising:
a mail receiving section which receives electronic mail to which an attachment file is attached and which is accompanied by accompanying information which describes modes of treating the attachment file in association with a plurality of recipient types into which recipients are categorized;
an attachment file processing section which processes the attachment file of the electronic mail received at the mail receiving section in accordance with the type of recipients on the basis of the accompanying information which accompanies the electronic mail; and
a mail sending section which sends the electronic mail the attachment file of which has been processed by the attachment file processing section to recipients of the electronic mail.

6. A mail receiving program storage medium having stored thereon a mail receiving program to be executed in a computer system to cause the computer system to receive electronic mail sent from a mail server which relays transmission and reception of electronic mail, the mail receiving program configuring on the computer system comprising:
a mail receiving section which receives electronic mail with information indicating whether or not an attachment file is excluded from the electronic mail;
a display which displays the electronic mail received at the mail receiving section; and
a display control section which, if an attachment file is excluded from the electronic file received at the mail receiving section, causes information indicating that an attachment file is excluded from the electronic mail to be displayed on the display along with the electronic mail.
